(19) United States
(12) Patent Application Publication
(10) Pub. No.: US 2007/0137609 A1
(43) Pub. Date: Jun. 21, 2007

(54) True rotary internal combustion engine

(76) Inventor: Dewey James Morse, Sierra Vista, AZ (US)

Correspondence Address: Dewey J. Morse, 3540 Plaza De La Yerba, Sierra Vista, AZ, 85650, US

(21) Appl. No.: 11/312,705

(22) Filed: Dec. 21, 2005

(51) Int. Cl. F02B 53/04

(52) U.S. Cl. 123/232

(57) ABSTRACT

A true rotary internal combustion engine (100) having a housing (1), wherein a primary cylinder (2) and a secondary cylinder (3) are defined, having a primary longitudinal axis (20) and a secondary longitudinal axis (30) therein. The primary longitudinal axis (20) having a primary axle (21) aligned thereto and a primary rotor (22) mounted thereon. The secondary longitudinal axis (30) having a secondary axle (31) aligned thereto and a secondary rotor (32) mounted thereon. The housing (1) having a housing end plate (40) installed at both ends of the housing (1) in a suitable way. Each housing end plate (40) having a primary axle opening (41), wherein the primary axle (21) is supported, and a secondary axle opening (42), wherein the secondary axle (31) is supported. The primary rotor (22) having a generally circular primary rotor base (23), and a fin (24) extending radially outward longitudinally from the primary rotor base (23) to contact a primary cylinder wall (4). The primary rotor base (23) and the primary cylinder wall (4) forming an annular pressure chamber (15) therebetween. The fin (24), rotating by the force of combusted fluids within the annular pressure chamber (15), thereby producing torque about the primary longitudinal axis (20). The primary rotor base (23) being in contact with the secondary rotor base (33), the fin (24) being in contact with the primary cylinder wall (4), and the secondary rotor base (33) being in contact with the secondary cylinder wall (5), thereby containing fluid pressure within the annular pressure chamber (15). The secondary rotor (32) having a cavity (34) extending longitudinally to allow the fin (24) to pass through without interference during each rotational cycle. The engine having a conventional forced air induction system (50), a conventional position sensor system (95), a conventional one-way directional valve assembly system (71), a conventional fuel injector system (90), a conventional spark plug system (92), and a computer (80) to synchronize, command, and control the operation of all systems therein, thereby maximizing performance and efficiency. The engine having other conventional components well known in the art, but not shown, including a starter, a battery, a cooling system, gears, pressure seals, alternators, motors, lubrication systems, and cooling systems.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND OF INVENTION

1. Field of Invention

This invention relates to rotary internal combustion engines, and in particular, to a true rotary internal combustion engine wherein all kinetically energetic engine component motion is rotational.

2. Prior Art

Various types of internal combustion engines are well known in the art. In the combustion cycle of the conventional piston engine, each piston must always come to a complete stop and reverse direction, and the piston requires a connecting rod and crankshaft to convert up and down motion into usable torque. Reciprocating motion wastes energy and reduces mechanical efficiency due to the wasted kinetic energy of the components. On the other hand, a true rotary engine generates torque wherein kinetically energetic components exhibit only rotational motion. However, reciprocating movement and other inefficiencies still exist to some degree in all previous art inventions of the rotary engine. In the true rotary internal combustion engine, all kinetically energetic engine component motions are accomplished without reciprocating motion, and other inefficiencies have been eliminated.

Rotary internal combustion engines have existed for many years. As shown in U.S. Pat. No. 650,661 to Stewart (1900), these engines typically include a cylindrical housing having a centrally mounted rotor coupled to an axial shaft. The rotor typically includes a rotor base and one or more fins extending from the rotor base. The combination of the rotor base and the cylindrical housing inner wall define an annular passage therebetween. Fluid pressure applied to a fin, forces the fin to move within the annular passage, thereby causing rotational motion of the rotor and the axial shaft about a longitudinal axis.

In one form of the previous art, shown in U.S. Pat. No. 1,219,829 to Marion (1917), reciprocating components arranged in a secondary cylindrical region of the housing provide a combustion chamber for fluids, wherein the combusted fluids expand and force a fin to rotate in the annular passage of the primary cylindrical region. The components shown performing this function are mechanically manipulated to allow the fin to pass by without interference. In performing this function, however, the invention exhibits unnecessary complexity and considerable wasted energy due largely to the reciprocating motion of the aforementioned components. The true rotary internal combustion engine is designed to overcome the disadvantages of this instance of prior art by replacing the aforementioned arrangement of many reciprocating components with a single rotary component, thereby providing a true rotary engine that is simple in design and easy to manufacture, wherein all kinetically energetic engine components exhibit rotary motion, as discussed at length herein.

Disadvantages of the previous art include design inadequacies, complicated construction, difficult manufacturing methods, and inefficient operation. Rotary engines of the previous art have proved to be unpractical for variety of reasons, however, the true internal combustion rotary engine has overcome these disadvantages.

3. Objects and Advantages

The true rotary internal combustion engine provides several advantages over the previous art. The true rotary internal combustion engine reduces complexity by having fewer components, facilitates ease of manufacture by having simpler component geometries, eliminates wasted reciprocating motion by having only rotational component motion, delivers a high thermal to mechanical energy conversion efficiency due to greater volume expansion ratios, increases power duty cycles by enabling torque output on every rotation when required, enables rotational velocities higher than conventional internal combustion engines by the inherent advantage of true rotational component motion, and utilizes the extremely fast computational ability of a computer to increase efficiency and optimize system performance. The computer and conventional systems of the true rotary engine have the ability to enable power output on each rotational cycle, on alternate cycles, or on variable cycle patterns. This ability allows the most favorable torque and operational efficiency for the desired load condition, thereby conserving fuel. The true rotary engine therefore provides a higher combined operating efficiency and torque producing capability than has existed heretofore in any rotary engine invention or in any conventional piston engine.

It is thus seen that a need remains for a true rotary engine that is simple in design, easy to manufacture, having kinetically energetic components exhibit only rotational motion, under the control of a computer to provide many operational advantages, as is presented herein.

### SUMMARY

The true rotary internal combustion engine has a housing with two overlapping cylindrical regions defined within. There is a primary cylinder having a primary longitudinal axis and a secondary cylinder having a secondary longitudinal axis. A primary axle is aligned along the primary longitudinal axis and a secondary axle is aligned along the secondary longitudinal axis. There are housing end plates constructed to conform to the shape of the housing, and bolted to the housing in a suitable way. Each housing end plate has a primary axle opening and a secondary axle opening, with unshown bearings, which support the primary axle and the secondary axle. A primary rotor is coupled to the primary axle and is positioned for rotation within the primary cylinder about the primary longitudinal axis. A secondary rotor is coupled to the secondary axle and is positioned for rotation within the secondary cylinder about the secondary longitudinal axis. The primary rotor has a primary rotor base, and a longitudinal fin extending radially outward from the primary rotor base, to contact a primary cylinder wall. The primary rotor base and the primary cylinder wall define an annular pressure chamber, wherein the fin rotationally transverses about the primary longitudinal axis by the force of combusted fluids. The secondary rotor has a secondary rotor base and a longitudinal cavity defined beneath the surface of the secondary rotor base. The cavity allows the fin to pass by the secondary rotor without interference during each rotational cycle. There is an air inlet port in the housing whereby compressed air enters the annular pressure chamber. There is an exhaust outlet port in the housing whereby fluids exit the annular pressure chamber. There is a fuel injector port in the housing having a conventional fuel injector installed therein. There is a spark plug port in the housing having a conventional spark plug installed therein. The air inlet port in the housing having a conventional one-way directional valve assembly installed therein, to enable or block the entry of compressed air into the annular pressure chamber. There is a conventional forced air induction system providing compressed air for the combustion of fuel and to purge combusted fluids from the annular pressure chamber. There is a conventional position sensor installed in a predetermined location to determine the rotational position of the primary rotor at all times. There is a computer with the ability to command and control all engine systems.

### DRAWINGS—FIGURES

FIG. 1 is an exploded view, in perspective, of a rotary engine embodying principles of a true rotary internal combustion engine in a preferred form.

FIG. 2 is a view in perspective of the construction of a housing in a preferred form, showing the approximate locations of an air inlet port, an exhaust outlet port, a fuel injector port, a spark plug port, a primary cylinder, a secondary cylinder, a primary cylinder wall, and a secondary cylinder wall.

FIG. 2A is a cross sectional view showing the approximate locations of the exhaust outlet port, an exhaust outlet conduit, the primary cylinder wall, and the secondary cylinder wall.

FIG. 2B is a cross sectional view showing the fuel injector port, a conventional fuel injector, a conventional fuel injector system, the primary cylinder wall, and the secondary cylinder wall.

FIG. 2C is a cross sectional view showing the spark plug port, a conventional spark plug, a conventional spark plug system, the primary cylinder wall, and the secondary cylinder wall.

FIG. 2D is a cross sectional view showing the air inlet port, a conventional one-way directional valve assembly, a conventional one-way directional valve assembly system, an air intake conduit, the primary cylinder wall, and the secondary cylinder wall.

FIG. 3 is a view in perspective showing the construction of a primary axle, a primary rotor, a primary rotor base, and a longitudinal fin in a preferred form.

FIG. 4 is a view in perspective showing the construction of a secondary axle, a secondary rotor, a secondary rotor base, and a longitudinal cavity in a preferred form.

FIGS. 5-8 are a series of end views of the true rotary engine of FIG. 1, showing in sequence the approximate positions, during rotation, of the primary rotor, the secondary rotor, the fin, the cavity, as well as indicating the open or closed state of the conventional one-way directional valve assembly, whereby torque is generated from the combustion of fuel during a typical power cycle.

### DRAWINGS—REFERENCE NUMERALS

1 housing
2 primary cylinder
3 secondary cylinder
4 primary cylinder wall
5 secondary cylinder wall
6 air inlet port
7 exhaust outlet port
8 fuel injector port
9 spark plug port
15 annular pressure chamber
16 combustion chamber
20 primary longitudinal axis
21 primary axle
22 primary rotor
23 primary rotor base
24 fin
30 secondary longitudinal axis
31 secondary axle
32 secondary rotor
33 secondary rotor base
34 cavity
40 housing end plate
41 primary axle opening
42 secondary axle opening
43 bolt
50 conventional forced air induction system
51 turbine section
52 turbine input port
53 turbine exhaust opening
54 induction system drive shaft
55 compressor section
56 compressor air intake opening
57 compressor outlet port
61 air intake conduit
62 exhaust outlet conduit
70 conventional one-way directional valve assembly
71 conventional one-way directional valve assembly system
80 computer
81 conventional position sensor system interface
82 conventional one-way directional valve assembly system interface
83 conventional fuel injector system interface
84 conventional spark plug system interface
90 conventional fuel injector system
91 conventional fuel injector
92 conventional spark plug system
93 conventional spark plug
94 conventional position sensor
95 conventional position sensor system
100 true rotary internal combustion engine

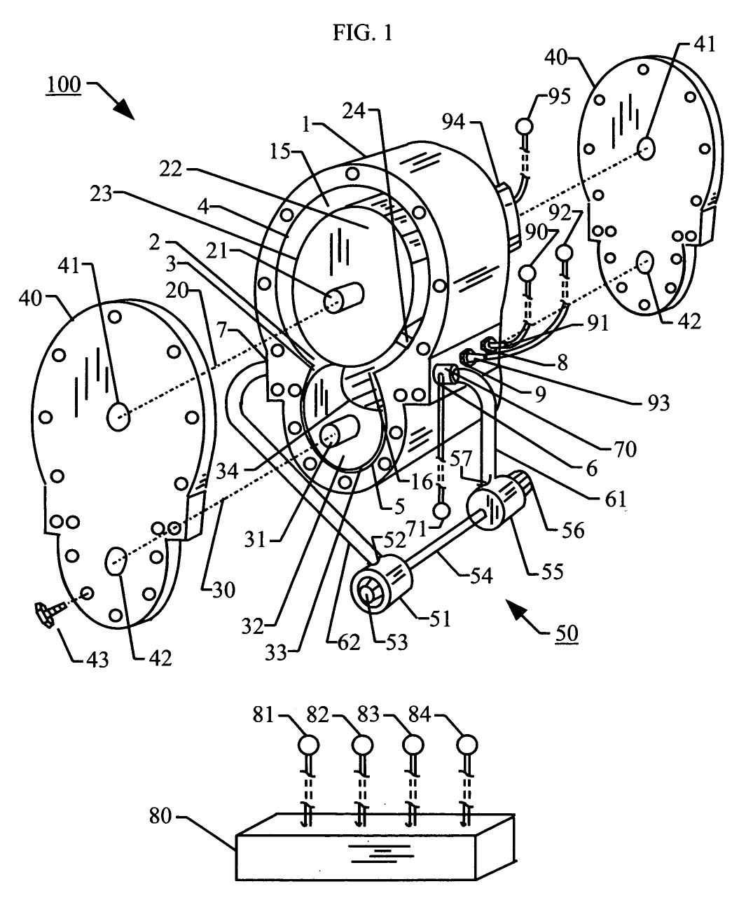

### DETAILED DESCRIPTION-FIGS. 1, 2, 2A, 2B, 2C, 2D, 3, and 4—PREFERRED EMBODIMENT

FIG. 1 shows a true rotary internal combustion engine 100, having a housing 1 and a housing end plate 40, wherein the housing end plate 40 is attached in a suitable way to the front of the housing 1, and an identical housing end plate 40 is attached to the back of the housing 1 in a suitable way, with a predetermined number of typical bolt 43. The combination of the housing 1, and the housing end plate 40, attached at each end of the housing 1, define a primary cylinder 2 and a secondary cylinder 3 within the housing 1. A primary longitudinal axis 20 is defined within the primary cylinder 2 and a primary axle 21 is aligned thereto. A secondary longitudinal axis 30 is defined within the secondary cylinder 3 and a secondary axle 31 is aligned thereto. Each end plate 40 has a primary axle opening 41 and a secondary axle opening 42, with unshown bearings coupled thereto. The primary axle 21 is supported within the primary axle opening 41 by the unshown bearings therein, and the secondary axle 31 is supported within the secondary axle opening 42 by the unshown bearings therein. A primary rotor 22 is mounted to the primary axle 21 and is positioned within the primary cylinder 2 for axial rotation therein. The primary rotor 22 has a generally circular primary rotor base 23 and a fin 24 extending longitudinally outward from the primary rotor base 23 to contact a primary cylinder wall 4. The primary rotor base 23 and the primary cylinder wall 4 define a generally annular pressure chamber 15 therebetween. A secondary rotor 32 is mounted to the secondary axle 31 and is positioned within the secondary cylinder 3 for axial rotation therein. The secondary rotor 32 has a generally circular secondary rotor base 33 and a cavity 34 defined longitudinally beneath the surface of the secondary rotor base 33. The secondary rotor base 33 contacts a secondary cylinder wall 5. The primary rotor base 23 contacts the secondary rotor base 33 throughout each rotational cycle, except wherein the fin 24 passes generally through the cavity 34.

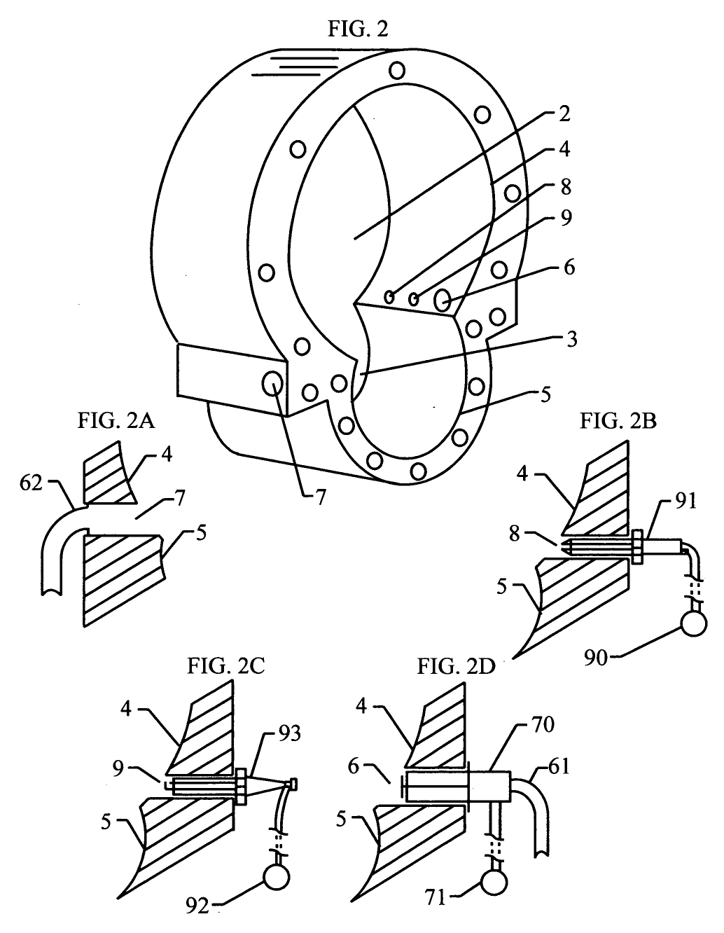

FIG. 2 shows the housing 1, the primary cylinder 2, the secondary cylinder 3, the primary cylinder wall 4, the secondary cylinder wall 5, the air inlet port 6, the exhaust outlet port 7, the fuel injector port 8, and the spark plug port 9, wherein all locations are approximate.

FIG. 2A shows in cross sectional view approximate locations of the exhaust outlet port 7, the exhaust outlet conduit 62, the primary cylinder wall 4, and the secondary cylinder wall 5.

FIG. 2B shows in cross sectional view the approximate locations of the fuel injector port 8, the conventional fuel injector 91, the conventional fuel injector system 90, the primary cylinder wall 4, and the secondary cylinder wall 5.

FIG. 2C shows in cross sectional view the approximate locations of the spark plug port 9, the conventional spark plug 93, the conventional spark plug system 92, the primary cylinder wall 4, and the secondary cylinder wall 5.

FIG. 2D shows in cross sectional view the approximate locations of the air inlet port 6, the conventional one-way directional valve assembly 70, the conventional one-way directional valve assembly system 71, the air intake conduit 61, the primary cylinder wall 4, and the secondary cylinder wall 5.

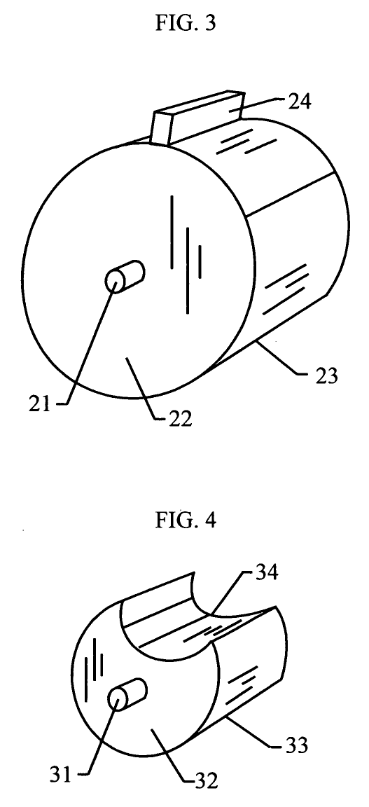

FIGS. 3 and 4 show approximate constructions of the primary axle 21, the primary rotor 22, the primary rotor base 23, the fin 24, the secondary axle 31, the secondary rotor 32, the secondary rotor base 33, and the cavity 34, whereby these components may be solid or hollow, and may be constructed in such a manner as to provide the best rotational balance for the engine.

FIG. 1 shows the conventional fuel injector 91 installed within the fuel injector port 8 in housing 1. The conventional fuel injector 91 is coupled to the conventional fuel injector system 90 to provide fuel to mix with air for combustion. The conventional spark plug 93 is installed within the spark plug port 9 in housing 1. The conventional spark plug 93 is coupled to a conventional spark plug system 92 to provide an electrical spark to ignite the fuel air mixture. The conventional one-way directional valve assembly 70 is installed within the air inlet port 6 in housing 1. The conventional one-way directional valve assembly 70 is coupled to a conventional one-way directional valve assembly system 71. There is a conventional position sensor 94 installed on the housing 1 to sense the rotational position of the primary rotor 22 at all times. The conventional position sensor 94 is coupled to a conventional position sensor system 95. A computer 80 has a conventional position sensor system interface 81, a conventional one-way directional valve assembly system interface 82, a conventional fuel injector system interface 83, and a conventional spark plug system interface 84, whereby the computer 80 commands and controls all aforementioned systems.

A conventional forced air induction system 50, has a turbine section 51, a turbine input port 52, a turbine exhaust opening 53, a compressor section 55, a compressor air intake opening 56, and a compressor outlet port 57. The turbine section 51 is connected to the compressor section 55 by an induction system drive shaft 54. The compressor section 55 intakes ambient air through the compressor air intake opening 56 and provides compressed air to the compressor outlet port 57. The compressed air passes through the air intake conduit 61, through the conventional one-way directional valve assembly 70, and into the air input port 6. The conventional one-way directional valve assembly 70, under command and control of the computer 80, either allows compressed air to enter, or does not allow compressed air to enter, the air inlet port 6. Compressed air is allowed to enter the air inlet port 6 when needed to enable the combustion of fuel in a combustion chamber 16 at the start of a power cycle, or when needed to exhaust and purge combusted fluids from the annular pressure chamber 15, at the end of the power cycle.

The power cycle is initiated when the fuel air mixture is ignited by the conventional spark plug 93. At the start of the power cycle, the fin 24 is positioned at a predetermined position counterclockwise past the air inlet port 6, wherein the conventional one-way directional valve assembly 70 is closed. At the end of the power cycle, the fin 24 is positioned at a position counterclockwise, and approximately juxtaposed, from the exhaust outlet port 7, whereby the conventional one-way directional valve assembly 70 is opened to allow compressed air into the air inlet port 6, forcing combusted fluids to be exhausted and purged from the annular pressure chamber 15.

The exhaust outlet conduit 62 connects the exhaust outlet port 7 to the turbine input port 52, wherein the turbine section 51 derives its torque from the force of fluids passing through to exit the turbine exhaust opening 53. The turbine section 51 conveys torque to the compressor section 55 by means of the air induction drive shaft 54. All combusted and purged fluids leaving the engine provide torque for the compression of air, thereby providing increased engine efficiency.

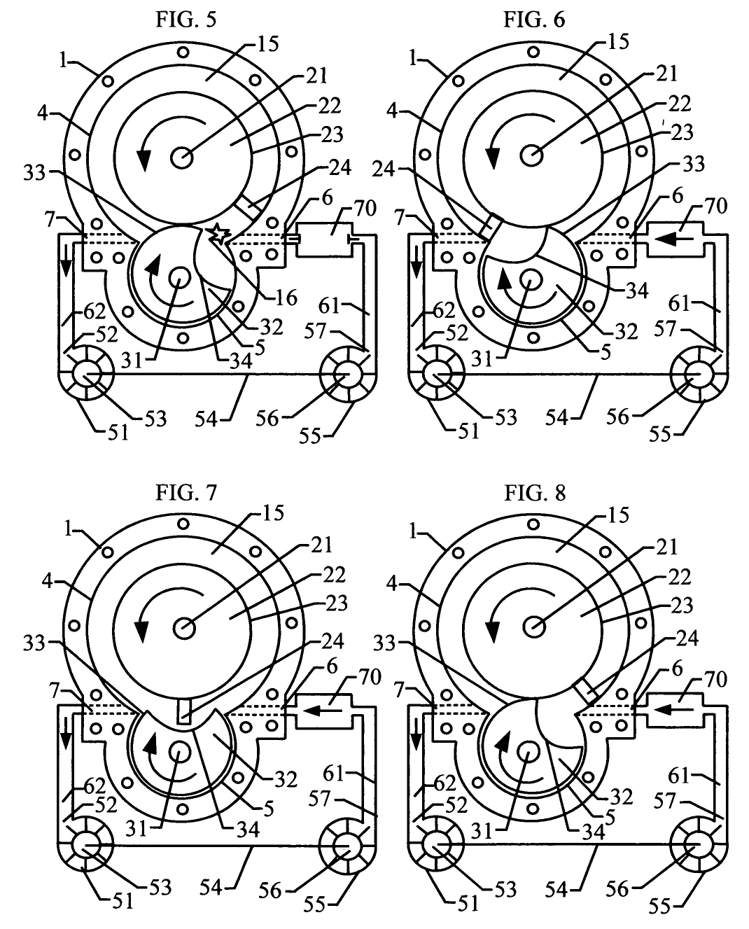

### DETAILED DESCRIPTION—FIGS. 5, 6, 7, AND 8—OPERATION

The initial operational sequence begins when the primary rotor 22 and the fin 24 rotate past the cavity 34 by means of an unshown conventional starter motor. The conventional one-way directional valve assembly 70 is open and compressed air is injected into the combustion chamber 16. When the fin 24 has rotated counterclockwise to a predetermined position past the air inlet port 6, the conventional fuel injector 91 injects fuel into the combustion chamber 16 and into the volume of compressed air entering from the air inlet opening 6, thereby creating a combustible mixture of air and fuel. At a predetermined time immediately thereafter, the conventional one-way directional valve assembly 70 is closed, and the combustion chamber 16 contains within a combustible mixture of air and fuel. Approximately simultaneously thereafter, an electric current is passed through the conventional spark plug 93, igniting the mixture of air and fuel, thereby causing fluid pressure to rise within the combustion chamber 16. The combusted fluids in the combustion chamber 16 expand into the annular pressure chamber 15, thereby applying a force to the fin 24, whereby the force is transmitted to the primary rotor 22 and the primary axle 21 causing rotation about the primary longitudinal axis 20. The primary axle 21 is in communication with the secondary axle 31, mechanically or otherwise, thereby causing the secondary axle 31 and the secondary rotor 32 to likewise rotate about the secondary longitudinal axis 30. Combustion fluids continue to expand into the annular pressure chamber 15 causing the fin 24 to rotate through the annular pressure chamber 15 for the remainder of the power cycle.

FIGS. 5-8 show the rotational cycle sequence of operations, wherein the position movements of the primary rotor 22, the fin 24, the secondary rotor 32, the cavity 34, and the open or closed state of the conventional one-way directional valve assembly 70 are approximately shown during a complete rotational cycle. FIG. 5 shows the start of the power cycle being initiated by the ignition of fuel in the combustion chamber 16. As the combustion fluids expand into the annular pressure chamber 15, torque is extracted as the fin 24 and the primary rotor 22 rotate about the primary longitudinal axis 20. Likewise, the secondary rotor 32 and cavity 34 rotate about the secondary longitudinal axis 30. As the combusted fluids expand, converting heat energy into mechanical energy, useful torque is extracted until the movement of the primary rotor 22 and the secondary rotor 32 reach the positions shown approximately at the end of the power cycle. FIG. 6 shows the approximate position of components at the end of the power cycle, when the conventional one-way directional valve assembly 70 is opened to introduce compressed air from the compressor section 55 into the annular pressure chamber 15, whereby combusted fluids are exhausted and purged. FIG. 7 illustrates approximate positions as the fin 24 passes through the cavity 34 without interference, whereby compressed air continues to purge exhaust fluids from the annular pressure chamber 15. FIG. 8 shows approximate positions as the fin 24 contacts the primary cylinder wall 4, and the secondary rotor base 33 contacts the primary rotor base 23, whereby a mixture of fuel and compressed air is introduced into the combustion chamber 16, as described previously. As the fin 24 rotates to the approximate position shown in FIG. 5, the rotational cycle is completed, and another power cycle may be initiated by the ignition of the mixture of fuel and compressed air. It should be understood that the angular positions and angular velocities of the primary axle 21 and the secondary axle 31 are precisely known by the computer 80 at all times during the rotational cycle. If torque is not required on every cycle, the momentum of the primary rotor 22 and the secondary rotor 32, will allow additional rotations to continue until a power cycle is once again enabled by the computer 80. In this manner, the primary rotor 22 and secondary rotor 32 complete any required number of energy conservation cycles, thereby conserving fuel until a power cycle is again initiated.

It should be further understood that some conventional elements of a typical engine, such as a battery, a starter, cooling systems, gears, seals, alternators, motors, and lubrication systems, as well as other details necessary for the conventional operation of an engine, have not been described herein, for clarity of explanation. These conventional components are of course readily adaptable to the described embodiment by one skilled in the art. It should also be understood that many modifications may be made to the specific preferred embodiment described herein, without departure from the spirit and scope of the engine as set forth in the following claims.

I claim:

1. A rotary engine comprising:
(a) a housing having a primary cylinder and a secondary cylinder therein, said primary cylinder having a primary longitudinal axis within said housing, and said secondary cylinder having a secondary longitudinal axis within said housing, said secondary longitudinal axis being parallel to said primary longitudinal axis, said housing having an air inlet port, an exhaust outlet port, a fuel injector port, and a spark plug port;
(b) a primary axle aligned along said primary longitudinal axis;
(c) a primary rotor coupled to said primary axle and positioned for rotation within said primary cylinder about said primary longitudinal axis, said primary rotor having a primary rotor base defined by a generally uniform circumference about said primary axle and having a longitudinal fin extending outward from said primary rotor base to a radially outermost point contacting a primary cylinder wall within said housing, said primary rotor base and said primary cylinder wall defining an annular pressure chamber therebetween;
(d) a secondary axle aligned along said secondary longitudinal axis;
(e) a secondary rotor coupled to said secondary axle and positioned for rotation within said secondary cylinder about said secondary longitudinal axis, said secondary rotor having a secondary rotor base defined by a generally uniform circumference about said secondary axle, and having a longitudinal cavity defined within the body of said secondary rotor, the improvement wherein being a true rotary engine, simple in design, having fewer components with simpler component geometries, thereby facilitating ease of manufacture.

2. Said engine of claim 1 wherein a conventional forced air induction system provides compressed air for combustion of fuel.

3. Said engine of claim 1 wherein a conventional one-way directional valve assembly blocks or enables compressed air to enter into said air inlet port.

4. Said engine of claim 1 wherein a conventional position sensor senses the rotational position of said primary rotor.

5. Said engine of claim 1 wherein a conventional fuel injector is installed within said fuel injector port.

6. Said engine of claim 1 wherein a conventional spark plug is installed within said spark plug port.

7. Said engine of claim 1 wherein a conventional fuel injector system provides fuel for said conventional fuel injector.

8. Said engine of claim 1 wherein a conventional spark plug system provides electricity for said conventional spark plug.

9. Said engine of claim 1 wherein a conventional position sensor system communicates with said conventional position sensor.

10. Said engine of claim 1 wherein a conventional one-way directional valve assembly system communicates with said conventional one-way directional valve assembly system.

11. Said engine of claim 1 wherein a computer controls all engine systems.

12. Said engine of claim 1 wherein means are provided for said conventional forced air induction system to recover energy of fluids exiting the engine.

13. Said engine of claim 1 wherein said primary rotor and said secondary rotor communicate and exhibit only rotational motion.

14. Said engine of claim 1 wherein said primary rotor, said fin, said secondary rotor, and said cavity have a predetermined design to prevent interference during rotation.

15. A rotary engine comprising:
(a) a housing and two oppositely disposed housing end plates, the combination of which define a primary cylinder and a secondary cylinder overlapping therein, said primary cylinder having a primary longitudinal axis within said housing, and said secondary cylinder having a secondary longitudinal axis within said housing, said secondary longitudinal axis being parallel to said primary longitudinal axis, said housing having an air inlet port, an exhaust outlet port, a fuel injector port with a conventional fuel injector installed therein, and a spark plug port with a conventional spark plug installed therein;
(b) a primary axle aligned along said primary longitudinal axis;
(c) a primary rotor coupled to said primary axle and positioned for rotation within said primary cylinder about said primary longitudinal axis, said primary rotor including a primary rotor base having a generally uniform circumference about said primary axle and a longitudinal fin extending from said primary rotor base to a radially outermost point making contact with a primary cylinder wall, said primary rotor base and said primary cylinder wall defining an annular pressure chamber therebetween;
(d) a secondary axle aligned along said secondary longitudinal axis;
(e) a secondary rotor coupled to said secondary axle and positioned for rotation within said secondary cylinder about said secondary longitudinal axis, said secondary rotor including a secondary rotor base having a generally uniform circumference about said secondary axle, and a longitudinal cavity defined beneath the surface of said secondary rotor base;
(f) a computer;
(g) a conventional one-way directional valve assembly installed in said air inlet port and controlled by means of said computer;
(h) a conventional forced air induction system controlled by means of said computer;
(i) a conventional fuel injector system controlled by means of said computer;
(j) an conventional spark plug system controlled by means of said computer;
(k) a conventional position sensor system controlled by means of said computer;
(l) a compression chamber, wherein the ignition of fuel causes combusted fluids to expand throughout said annular pressure chamber, urging said fin, said primary rotor, and said primary axle to rotate within said housing, about said primary longitudinal axis, thereby providing torque for external power and likewise generating torque from exhaust fluids for operation of said conventional forced air induction system, the improvement therein being a true rotary engine, having said computer enabling efficient operation and producing torque over a wide variety of operating conditions.

16. Said engine of claim 15 whereby said fin on said primary rotor, and said cavity have predetermined forms with means to interact during rotation without interference.

17. Said engine of claim 15 wherein said primary cylinder and said secondary cylinder have predetermined dimension ratios whereby torque and efficiency are maximized.

18. Said engine of claim 15 wherein said primary rotor base and said secondary rotor base have predetermined dimension ratios whereby torque and efficiency are maximized.

19. Said engine of claim 15 wherein said computer has means to enable or disable power cycles while the engine is functioning, thereby conserving fuel and energy.

20. A method of providing rotary engine power, comprising:
(a) providing a primary rotor and a secondary rotor within a housing, having rotary motion therein, with means to extract torque from combusted fluids,
(b) providing a longitudinal fin on said primary rotor with means to convert urging of combusted fluids into rotary motion,
(c) providing a longitudinal cavity within said secondary rotor with means for said fin to rotate thereby without interference,
(d) providing said primary cylinder, said secondary cylinder, said primary rotor, said secondary rotor, and said fin with means to contain pressurized fluids,
(e) providing a computer with means to control compressed air intake, fuel injection, and ignition of fuel,
(f) providing said housing and an annular pressure chamber with means to extract energy from combusted fluids within said annular pressure chamber and from exhaust fluids exiting said annular pressure chamber,
(g) providing said computer and systems with means to generate torque on continuous or variable power cycles, the improvement therein being an efficient low cost true rotary internal combustion engine of simple design, having the ability to use a wide variety of fuels for low cost operation, and having rotary motion of components enhancing the performance of energy conservation devices and electro-mechanical machines.
